(19) United States
(12) Patent Application Publication
(10) Pub. No.: US 2016/0155275 A1
(43) Pub. Date: Jun. 2, 2016

(54) TICKET DISPENSER

(71) Applicant: FASTRAK RETAIL (UK) LIMITED, Macclesfield, Cheshire (GB)

(72) Inventors: John Barrett, Stockport (GB); Steve Matthews, Stockport (GB); Paul Shardlow, Macclesfield (GB)

(21) Appl. No.: 14/903,563

(22) PCT Filed: Jul. 9, 2014
(86) PCT No.: PCT/GB2014/052092

§ 371 Date: Jan. 7, 2016

(30) Foreign Application Priority Data
Jul. 10, 2013 (GB) 1312394.8

(51) Int. Cl. G07B 3/04; B65H 5/36; G07B 5/08; B65H 5/16

(52) U.S. Cl. CPC G07B 3/04; B65H 5/16; B65H 5/36; G07B 5/08

(57) ABSTRACT

A ticket dispenser for dispensing a ticket from a pack of tickets having first and last tickets at opposite ends of the pack and each ticket having opposed first and second edges, the ticket dispenser comprising: a ticket rack assembly having a rack with a support platform for receiving the pack of tickets with first edges against the support platform, and a ticket pack biasing mechanism configured to bias against a face of the last ticket of the C pack and to urge the last ticket towards the first ticket; a ticket housing for preventing unauthorised external access to the pack of tickets, the ticket housing comprising a ticket dispensing slot; and a ticket dispensing mechanism configured to dispense the first ticket from the pack of tickets, the ticket dispensing mechanism comprising a dispensing control member connected to a ticket ejector, the ticket ejector having a ticket edge engagement feature configured to engage with a first edge of the first ticket, the ticket ejector being operable by movement of the dispensing control member to slide the first ticket from the pack and away from the platform and to dispense the second edge of the first ticket through the ticket dispensing slot.

### FIELD OF INVENTION

The present invention relates to a ticket dispenser for dispensing a ticket from a pack of separate, flexible tickets that are mounted in the dispenser, and more particularly, but not exclusively, for dispensing scratch cards.

### BACKGROUND

GB205164 describes a known ticket dispenser for dispensing thick railway tickets, which receives a stack of separate tickets, laid on and parallel to the surface of a flat horizontal platform, and is configured to dispense the lowermost ticket (i.e. the ticket adjacent the platform) from the stack. The dispenser is designed for a customer to operate, to self-issue a ticket. The ticket dispenser is operated by pushing a pivoting panel into the base of the dispenser, which operates a complex mechanical linkage to drive a ticket ejector. The ticket ejector is slidably connected to the platform, and engages the back edge of a ticket to dispense the front edge of the lowermost ticket out through a dispensing aperture, towards the customer.

Disadvantageously, in such a ticket dispenser, the display face of the ticket to be dispensed does not face the customer and cannot be viewed by the customer prior to dispensing. Also, although the ticket is conveniently dispensed towards the customer, the dispensing operation is not controlled by the retailer, consequently requiring additional security features for dispensing valuable tickets. Further, such a dispenser is only suited to dispensing relatively rigid tickets in order that the dispensing edge aligns with the dispensing slot, and would risk jamming if the dispensing edge of a ticket should become buckled. Yet further, the dispenser requires a mechanically complex mechanical linkage between the pivoting panel and the ticket ejector.

### SUMMARY OF THE DISCLOSURE

According to an aspect of the present invention, there is provided
a ticket dispenser for dispensing a ticket from a pack of tickets having first and last tickets at opposite ends of the pack and each ticket having opposed first and second edges, the ticket dispenser comprising:
a ticket rack assembly having a rack with a support platform for receiving the pack of tickets with first edges against the support platform, and a ticket pack biasing mechanism configured to bias against a face of the last ticket of the pack and to urge the last ticket towards the first ticket;
a ticket housing for preventing unauthorised external access to the pack of tickets, the ticket housing comprising a ticket dispensing slot; and
a ticket dispensing mechanism configured to dispense the first ticket from the pack of tickets, the ticket dispensing mechanism comprising a dispensing control member connected to a ticket ejector, the ticket ejector having a ticket edge engagement feature configured to engage with a first edge of the first ticket, the ticket ejector being operable by movement of the dispensing control member to slide the first ticket from the pack and away from the platform and to dispense the second edge of the first ticket through the ticket dispensing slot.

Advantageously, standing the tickets on the edge on the support platform enables the ticket to be dispensed by a low complexity mechanical dispensing mechanism. Further, the dispensing mechanism may be operable by depression of the dispensing control member a counter onto which the ticket dispenser may be mounted, thereby requiring a low complexity mounting arrangement.

The dispensing mechanism may comprise a dispensing lever, part of the lever comprising the dispensing control member and being operable to drive the ticket ejector. The dispensing control member may be a depressible end of the dispensing lever that projects beyond the housing for operation by an operator, and the dispensing lever may be pivoted between the depressible end and the connection with the ticket ejector. Advantageously, the dispensing lever arrangement enables a mechanically simple, robust and inexpensive mechanism to be used for dispensing tickets.

A resiliently deformable member (e.g. a compression or tension spring) may bias the dispensing lever into a position of readiness for dispensing the first ticket. Advantageously, the resiliently deformable member ensures that the ticket dispenser remains primed dispensing the first ticket.

The ticket ejector may be pivotably connected to the dispensing control member. The ticket ejector may be pivotably connected to the dispensing lever remote from the depressible end. Advantageously, the pivotable connection eases manufacturing tolerances over a rigid connection between the ticket ejector and the dispensing lever. Further, the pivotable connection enables the ticket ejector to be biased against the front wall of the ticket housing, to impede a ticket from passing between the ticket ejector and the front wall, which could otherwise jam the ticket dispensing mechanism.

The ticket ejector has a leading edge, which is shaped to deflect the approaching first edge of a ticket towards the ticket pack, in the event that a partially dispensed ticket is returned to the pack. The leading edge of the ticket ejector is the edge closest to the ticket dispensing slot.

The leading edge of the ticket ejector may comprise a bevelled face that faces towards the ticket pack (i.e. the bevelled face is bevelled away from the customer-facing side of the housing). Advantageously, the leading edge of the ticket ejector deflects a returned ticket to rejoin the ticket pack, thereby preventing a returned ticket from passing between the ticket ejector and the housing, which could otherwise jam the ticket dispensing mechanism.

The ticket edge engagement feature may be less than 0.5 mm wide, and preferably less than 0.4 mm wide. A width of less than 0.5 mm is less than about ⅚ ths of the thickness of a standard ticket, which has a thickness of about 0.6 to 0.7 mm. Advantageously, a width of less than 0.5 mm or less than 0.4 mm is less than the width of a ticket, which commonly has a thickness of 0.6 to 0.8 mm, and advantageously prevents the ticket edge engagement feature from engaging with the edge of more than one ticket during a dispensing operation. The ticket ejector and an adjacent edge of the support platform may comprise an arrangement of projections and corresponding recesses configured for slideable mutual engagement throughout the range of movement of the ticket ejector during dispensing. The ticket ejector may comprise a plurality of grooves and the ticket rack may comprise a corresponding plurality of teeth for slideable engagement within the grooves. Alternatively, the ticket rack may comprise a plurality of grooves and the ticket ejector may comprise a corresponding plurality of teeth for slideable engagement in the grooves. Advantageously, the arrangement prevents a ticket-sized gap from arising between the ticket ejector and the rack, into which the first edge of a ticket could fall, which might otherwise jam the ticket dispensing mechanism.

The ticket housing may be configured for a display face of the first ticket to be viewable by a customer prior to the first ticket being dispensed.

The housing may be transparent. The customer-facing side of the housing may comprise a viewing window for viewing a display face of the first ticket. Advantageously, a transparent housing or a viewing window enables the display face of the first ticket to be viewed clearly by the customer.

The ticket dispenser may be configured to bias the pack of tickets towards a customer-facing side of the housing. Advantageously, biasing the pack of tickets towards the customer-facing side of the housing enables the display face of the first ticket to be more clearly viewed by the customer.

A slideable locking member may be provided that is slideable between an unlocked position in which the dispensing control member may be operated to dispense a ticket, and a locked position in which the locking member obstructs movement of the dispensing control member. Advantageously the slideable locking member may provide a simple security feature to hinder unauthorised ticket dispensing.

The ticket dispenser may comprise a counter base for fitting to a retail counter, to which the housing and/or rack detachably connects, and a slideable locking member configured to prevent detachment of the ticket housing and/or ticket rack assembly from the counter base when the slideable locking member is in a locked position. Advantageously the slideable locking member may provide a simple security feature to hinder unauthorised removal of the rack and housing from a retail counter to which the counter base is secured.

The counter base may connect with the ticket rack assembly by the mutual engagement of connection elements of the counter base with connection windows of the ticket rack assembly, and the engagement of connection elements of the counter base from connection windows of the ticket rack assembly may be by resilient deformation of connection elements, and the slideable locking member may be configured to prevent the resilient deformation of at least one of the connection elements, when the slideable locking member is in a locked position. Advantageously, disengagement by resilient deformation provides a simple detachable connection between the base and the housing and/or rack, which may be simply locked.

The housing may have a customer-facing first side and an opposed operator-facing second side, wherein the dispensing control member projects from the second side, and the ticket dispensing slot is provided adjacent the first side in a top face of the housing, or the dispensing slot is provided in the first side. Advantageously, this enables a ticket to be issued close to the customer, whilst the operator retains control over operation of the ticket dispensing mechanism.

The ticket dispensing slot may have a plurality of projections into the slot. Advantageously, the projections may be dimensioned to prevent more than one ticket from being dispensed simultaneously, whilst enabling a ticket to be dispensed when slightly buckled. The projections may reduce friction between the slot and the dispensed ticket.

The projections may be projections from an edge of the slot adjacent the top face of the housing. Advantageously, projections extending from the top face of the housing will not interfere with the dispensing of a single ticket, when the dispensing edge of the dispensing ticket slides up the inner surface of the front wall of the ticket housing.

The projections may be in end regions of the dispensing slot, e.g. projections may be provided in the end thirds of the length of the slot, or in the end quarters of the length of the slot. The projections may be absent from a central region (e.g. the central third of the length of the slot). The first ticket may buckle in a central region, and advantageously by providing a central region of the dispensing slot without projections, a centrally buckled ticket may be more easily dispensed without jamming across the dispensing slot. The projections may be located at the ends of the dispensing slot. One or a plurality of projections may be provided in each end region of the dispensing slot.

The projections may be configured to limit the maximum dispensing thickness to less than 1.2 mm, and preferably less than 1.0 mm. A maximum dispensing thickness of less than 1.2 mm or less than 1.0 mm is less than twice the width of a standard ticket having a thickness of 0.6 to 0.7 mm. Advantageously this maximum dispensing thickness prevents more than one ticket from being dispensed through the ticket dispensing slot simultaneously.

The width of the ticket edge engagement feature may be 40 to 60% of a maximum dispensing thickness of the slot. The ticket dispenser may be configured for operation with a particular thickness of ticket, e.g. the maximum dispensing thickness of the dispensing slot may be approximately 1.5 times the thickness of a ticket, and the width of the ticket edge engagement feature may be approximately 0.75 times the thickness of a ticket.

The ticket edge engagement feature may be narrower than the minimum width of the ticket dispensing slot. The ticket edge engagement feature may be less than half the minimum width of the ticket dispensing slot. Advantageously, the ticket dispensing slot is dimensioned to permit dispensing of no more than one ticket having a minimum width that is wider than the thickness of one ticket and narrower than the thickness of two tickets, and the ticket edge engagement feature is dimensioned to engage with no more than one ticket, by extending across only part of the edge of the first ticket as it is dispensed.

The inner face of the customer-facing side of the housing may be configured to contact and guide the second edge of the first ticket towards the dispensing slot, as the first ticket is dispensed. Advantageously, such guiding enhances the reliability of ticket dispensing.

The inner face of the customer-facing side of the housing may be provided with guiding ribs configured to contact and guide the second edge of the first ticket towards the dispensing slot, as the first ticket is dispensed. Advantageously, such guiding enhances the reliability of ticket dispensing, reduces abrasion of the inner face, through which the tickets are dispensed, and reduces the force required to dispense the first ticket.

The inner surface of the customer-facing side of the housing may be angled at an acute angle to the support platform to extend partially over the pack of tickets. Advantageously, the angling of the inner face enhances contact with the dispensing second edge of the first ticket, reducing buckling of the second edge, and thereby enhancing the guiding of the first ticket towards and through the dispensing slot, during dispensing.

The inner surface of the customer-facing side of the housing may be curved back towards the pack of tickets. Advantageously, curvature of the inner face enhances contact with the dispensing edge of the ticket being dispensed, thereby enhancing guiding of the ticket as it is dispensed. Further, curving the dispensing ticket back towards the pack may further enhance the maintenance of a straight second edge, to enhance the reliability with which the second edge is guided towards and passes through the dispensing slot, during dispensing.

### BRIEF DESCRIPTION OF THE DRAWINGS

Embodiments of the invention are further described hereinafter with reference to the accompanying drawings, in which:

FIGS. 1A and 1B illustrate assembled views of the ticket dispenser from opposite sides;

FIG. 2 illustrates an exploded view of the ticket dispenser;

FIG. 3A illustrates the ticket dispenser with the ticket housing disassembled from the ticket rack assembly, and

FIG. 3B illustrates the ticket dispenser in which the removable part of the ticket dispenser assembly has been detached from the counter base, which may be permanently connected to a retail counter;

FIG. 4 illustrates a cut-away view through the ticket dispenser;

FIG. 5A shows a cross-sectional view through the ticket housing and

FIG. 5B shows a plan view of the housing from above;

FIG. 5C shows a partially cut-away side view of the ticket dispenser and corresponding enlargement;

FIG. 5D shows a perspective view of the upper part of the housing;

FIGS. 5A-1, 5B-1 and 5C-1 respectively show enlarged views of parts of FIGS. 5A, 5B and 5C;

FIG. 6A shows a partially cut-away side view of the ticket dispenser with enlargements of part of the ticket ejector;

FIGS. 6A-1 and 6A-2 show enlarged views of parts of FIG. 6A;

FIG. 6B shows a side view of the ticket dispenser with a cut-away of the ticket assembly rack and enlargements;

FIGS. 6B-1 and 6B-2 show enlarged views of parts of FIG. 6B;

FIG. 6C shows a cut-away view through the ticket rack assembly;

FIG. 6D shows a perspective view of the ticket dispenser with a partial cut-away through the ticket housing;

FIG. 7A shows a side view of the ticket assembly rack that is unlocked;

FIG. 7B shows a corresponding cross-sectional view;

FIG. 7B-1 shows an enlarged view of part of FIG. 7B; and

FIG. 8A shows a side view of the ticket assembly rack that is locked;

FIG. 8B shows a corresponding cross-sectional view;

FIG. 8B-1 shows an enlarged view of part of FIG. 8B.

### DETAILED DESCRIPTION

In the described embodiment, like features have been identified with like numerals, albeit in some cases having one or more of suffix letters.

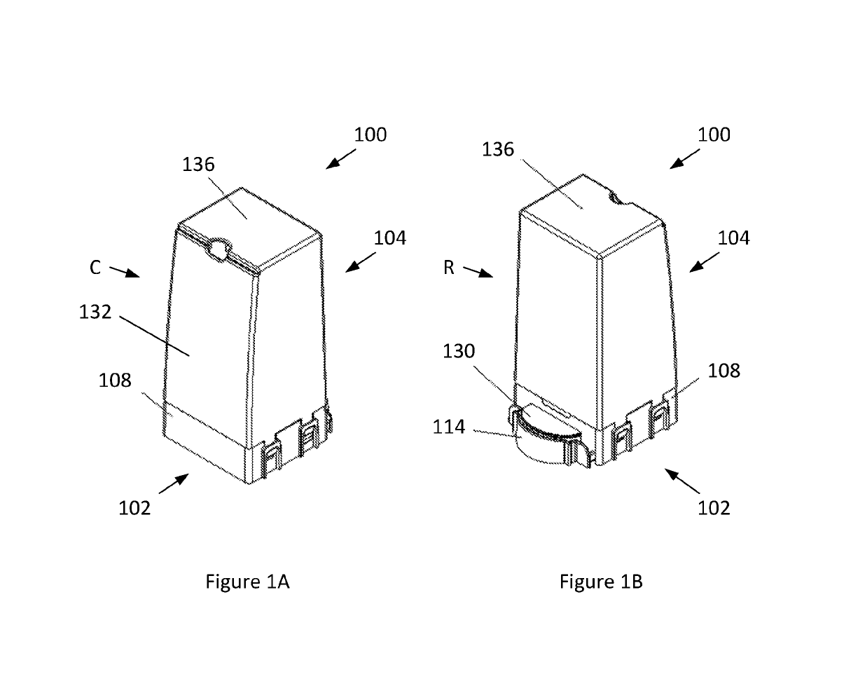

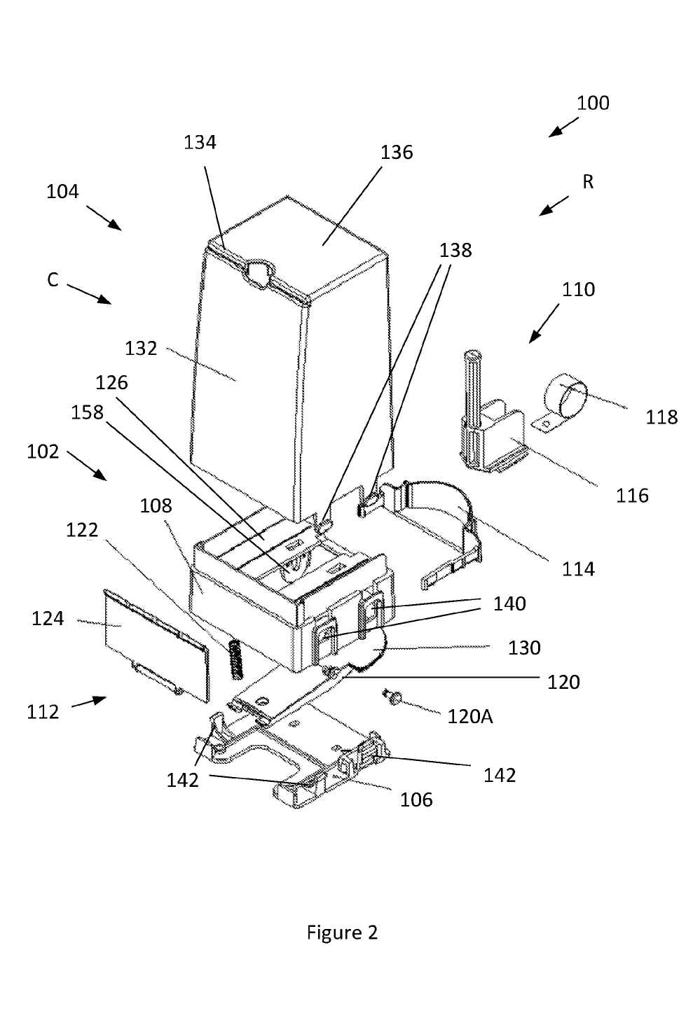

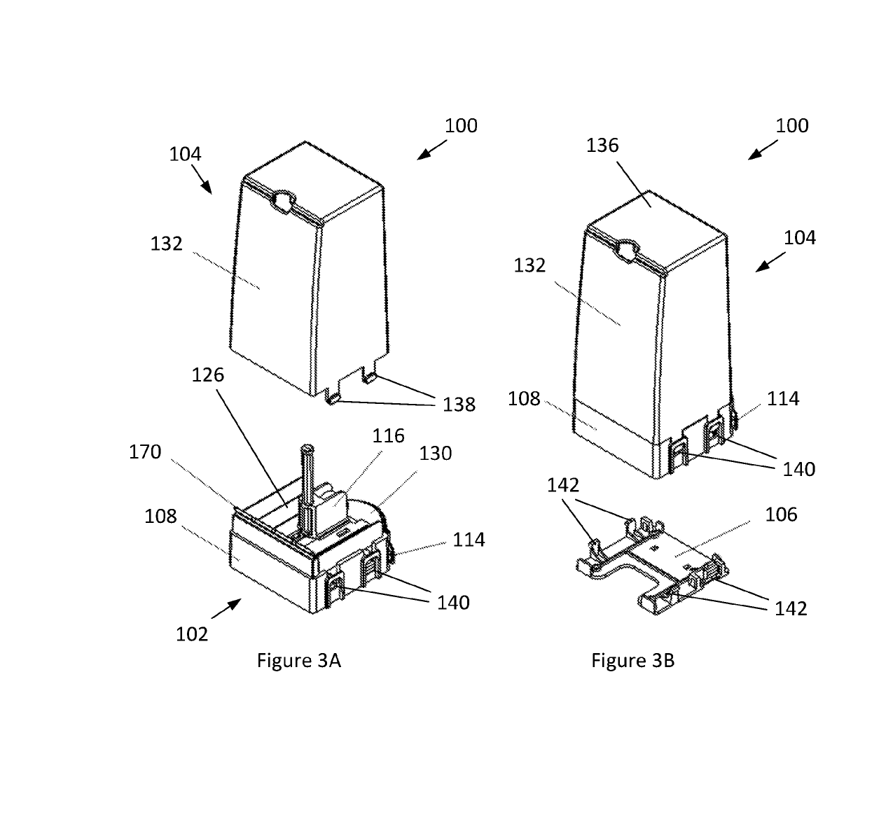

FIGS. 1A and 1B respectively show the fully assembled ticket dispenser 100 from a customer-facing side C and an opposed retailer-facing side R, FIG. 2 shows an exploded view of the ticket dispenser, and FIGS. 3A and 3B show partially disassembled views of the ticket dispenser.

The ticket dispenser 100 comprises a ticket rack assembly 102, a ticket housing 104, and a counter base 106.

The ticket rack assembly 102 comprises a ticket rack 108, a ticket biasing mechanism 110, a ticket dispensing mechanism 112, and a lock 114. The ticket biasing mechanism 110 comprises a pusher unit 116 and a torsion spring 118 for driving the pusher unit. The ticket dispensing mechanism 112 comprises a dispensing lever 120, a pivoting peg 120A, a compression spring 122 and a ticket ejector 124.

The ticket rack 108 has a support platform 126 for supporting a pack of separate tickets (i.e. a stack of parallel disconnected tickets) that are stood on edge. The pusher 116 is driven by the torsion spring 118, and biases against the back of the pack of tickets stood on the support platform 126 (i.e. ticket biasing mechanism 110 biases against the last ticket that would be dispensed from the pack), and slides along the platform 126 towards the ticket ejector 124, as the tickets are successively dispensed from the pack. The front of the pack of tickets (i.e. the first ticket to be dispensed) is biased against the ticket ejector 124. The dispensing lever 120 is pivotably mounted on the pivoting peg 120A in a bracket 158 beneath the platform 126, and is pivotably connected to the ticket ejector 124. Between the pivotable mounting of the dispensing lever 120 and the ticket ejector 124, the dispensing lever is biased away from the platform 126 by the compression spring 122. The opposite end of the dispensing lever 120 from the ticket ejector 124 is provided with a depressible end 130, which projects beyond the ticket rack 108, so that it may be pressed down on by the retailer (operator) to perform a dispensing operation to dispense the first ticket. The lock 114 provides a moveable curtain-like wall that is shaped in correspondence with the depressible end 130.

The ticket housing 104 has a curved front wall 132 on the customer-facing side C for facing the customer. The front wall 132 is curved, and extends backwards towards the retailer operating side R, as it rises up from the ticket assembly rack 102. A ticket dispensing slot 134 is provided at the edge between in the top face 136 of the housing 104 and the front wall 132.

The ticket housing 104 is detachably connected to the ticket rack assembly 102, by first resiliently deformable clipping arms 138, which are configured to engage in clipping windows 140 in the ticket rack 108. FIG. 3A shows the ticket dispenser 100 with the ticket housing 104 detached to enable the ticket rack assembly 102 to be restocked with a pack of tickets (not shown). The ticket housing 104 is detached by pressing in the ends of the first clipping arms 138, so that they become disengaged from the clipping windows 140.

The counter base 106 is configured for attachment to a retail counter. The ticket rack assembly 102 is detachably connected to the counter base 106, by second resiliently deformable clipping arms 142, which are also configured to engage in the clipping windows 140 in the ticket rack 108. FIG. 2B shows the ticket dispenser 100 with the upper part of the ticket dispenser assembly 102 and 104 detached from the counter base 106, enabling the upper part to be removed from the counter base and thus from the retail counter for secure storage. The ticket rack assembly 102 is detachable from the counter base 106 by pressing in the ends of the second clipping arms 142, so that they become disengaged from the clipping windows 140.

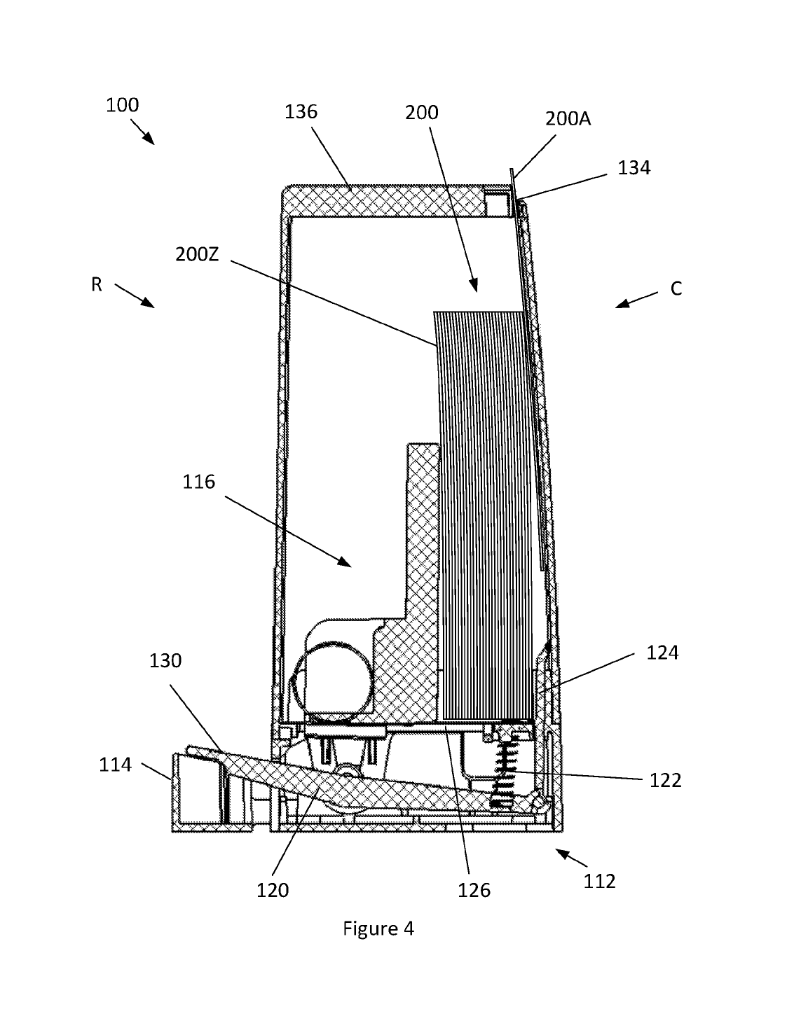

FIG. 4 shows the internal arrangement of the ticket dispenser 100 in a cut-away view along a central plane extending between the retailer-facing R and customer-facing C sides of the dispenser. FIG. 4 additionally shows a pack of separate tickets 200 loaded onto the support platform 126 of the ticket rack 108.

In use, each operation of the ticket dispensing mechanism 112 will successively dispense the first ticket 200A from the ticket pack 200. The first ticket 200A is the ticket closest to the front wall 132, on the customer-facing side C of the ticket dispenser 100. The ticket that will be dispensed last from the pack 200 is referred to as the last ticket 200Z. The last ticket 200Z is the ticket that is furthest from the front wall 132. The pusher unit 116 biases against the last ticket 200Z towards the front ticket 200A, to bias the pack 200 towards the front wall 132.

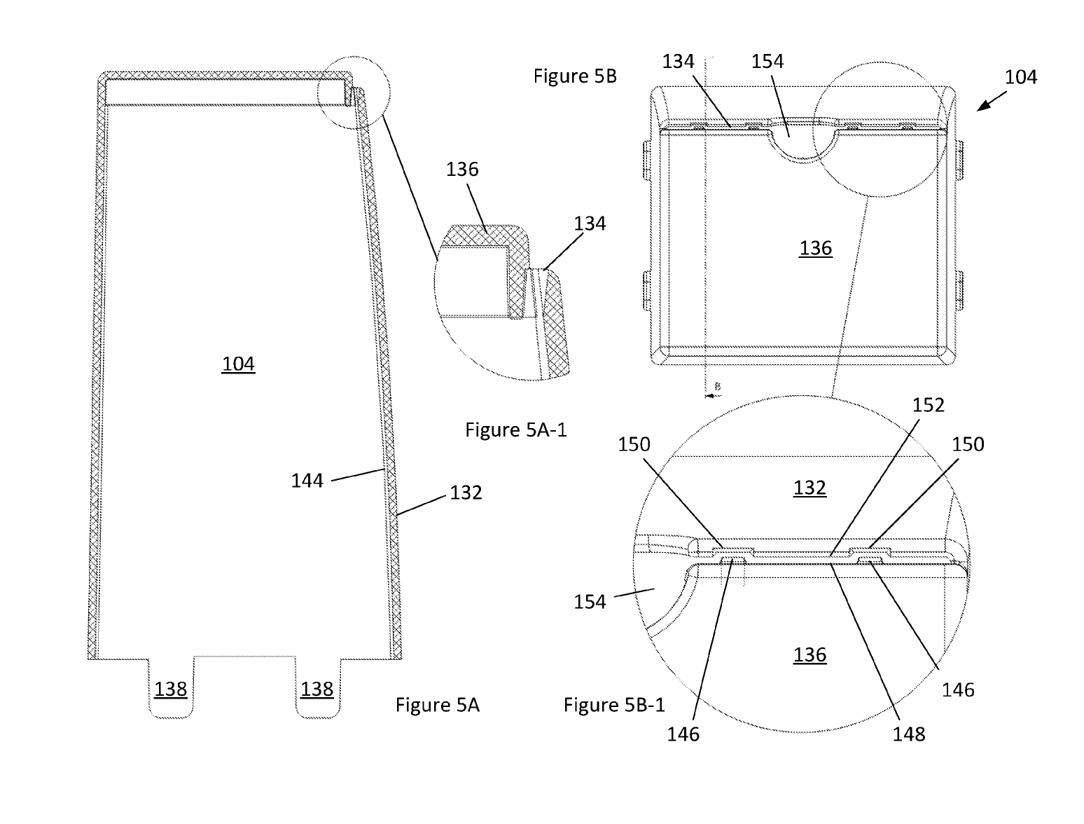

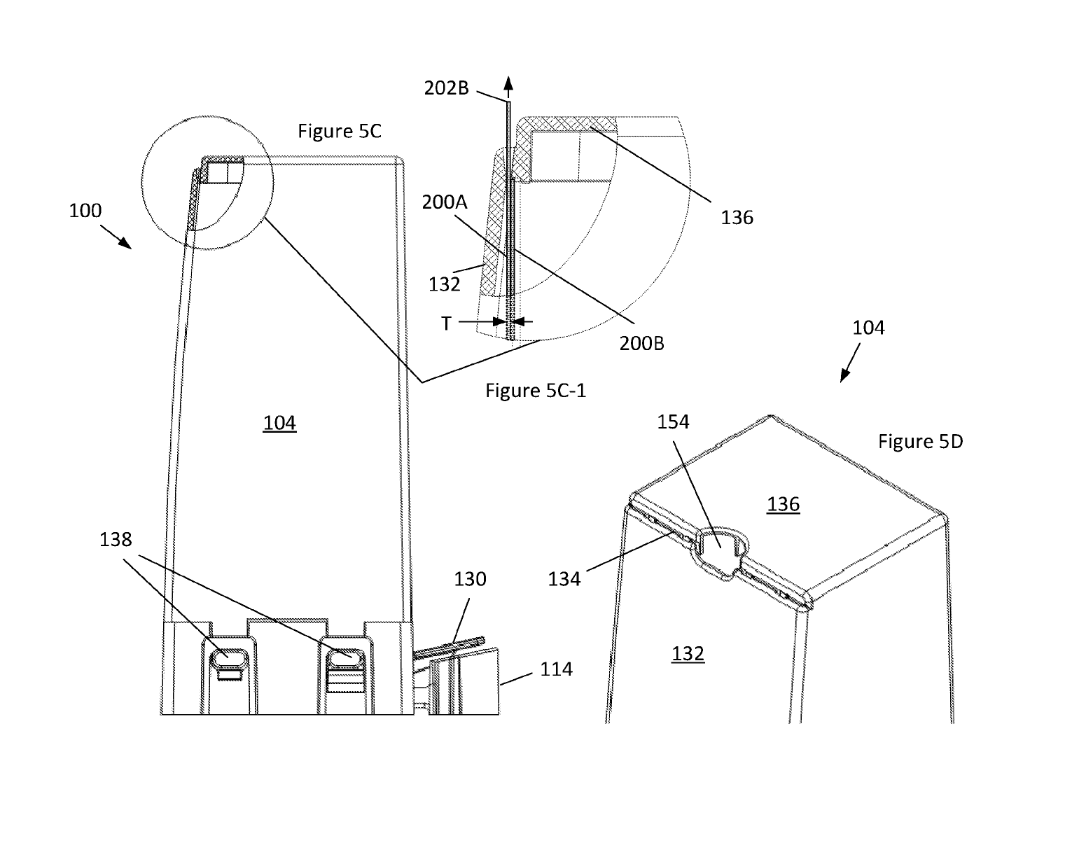

FIGS. 5A to 5D show views of the ticket housing 104. In the present embodiment, the ticket dispensing slot 134 is provided at the edge between the front wall 132 and the top face 136, although it will be appreciated that it may be provided in an alternative location to which a ticket may be dispensed from the customer-facing side C of the pack of tickets 200, e.g. the slot may be located in the front wall 132 of the ticket housing 104. The inner surface 144 of the front wall 132 is shaped to lead the dispensing edge of a ticket to the dispensing slot 134, as it is dispensed. The inner surface 144 is angled back over the ticket pack 200, which enhances contact between the dispensed edge 202B of the first ticket 200A and the inner surface, as the first ticket is dispensed. Also, during dispensing, the first ticket 200A may become curved in correspondence with the curvature of the inner surface 144 (e.g. the part of the first ticket adjacent the dispensing second edge 202B may become curved), which may reduce buckling of the dispensing edge as the first ticket approaches the dispensing slot 134.

Further, the inner surface 144 of the front wall 132 has a gently concave curvature (at least the part of the inner surface proximate the dispensing slot 132), viewed from the side, which may further enhance contact with the dispensing second edge 202B of the first ticket 200A, and further reduce buckling of the dispensing second edge. The backwards angling of the inner surface of the front wall, and optionally the curvature of the inner surface, may particularly enhance the dispensing of thin, flexible tickets.

In an alternative embodiment, the inner face of the front wall may be provided with ribs to guide the first ticket to the ticket dispensing slot. The running surfaces of the ribs, along which the dispensing ticket is guided, may be angled back over the ticket pack, and may have a gentle curvature. For example, the front wall may be flat with ribs projecting from the front wall, having a height (i.e. the amount by which they extend from the front wall) that increases towards the slot.

The dispensing slot 134 is configured for use with tickets having a ticket thickness T in a chosen range (e.g. with a tolerance of ±20% to allow for manufacturing tolerances). The dispensing slot 134 has projections 146 that extend into the slot from the edge 148 of the slot adjacent the top face 136 of the housing. Accordingly, when only a single ticket 200A approaches the dispensing slot 134, with its dispensing edge sliding up the inner surface 144 of the front wall 132, the dispensing edge will pass out through the dispensing slot without interacting with the projections 146. However, if the second ticket 200B in the pack should also become drawn towards the dispensing slot 134 by the movement of the first ticket 200A, the minimum width of the slot will prevent the second ticket from passing out through the dispensing slot, e.g. the dispensing edge of the second ticket will engage with the projections 146, thereby blocking the second ticket from being dispensed, as shown in FIG. 5C-1. A corresponding rebate 150 is provided in the opposite edge 152 of the dispensing slot, opposite each projection 146, which enables the slot 134 to be more easily formed when the ticket housing 104 is manufactured by an injection moulding process. Projections 146 are absent from the central region of the dispensing slot 134, which may facilitate the dispensing of a buckled ticket 200A. The middle of the dispensing slot 134 is provided with a cut-out in each edge 148 and 152 to enable a customer to more easily grasp a dispensed ticket 200A having a dispensing second edge 202B that has passed only a short distance through the dispensing slot. Although the dispensing slot 134 is illustrated with a plurality of projections 146 in each end region of the slot, alternatively just a single projection may be provided in each end region of the slot. Although in the illustrated embodiment, the outermost two of the four projections 146 are each spaced apart from the respective end of the dispensing slot 134, alternatively projections may be provided at the ends of the dispensing slot 134.

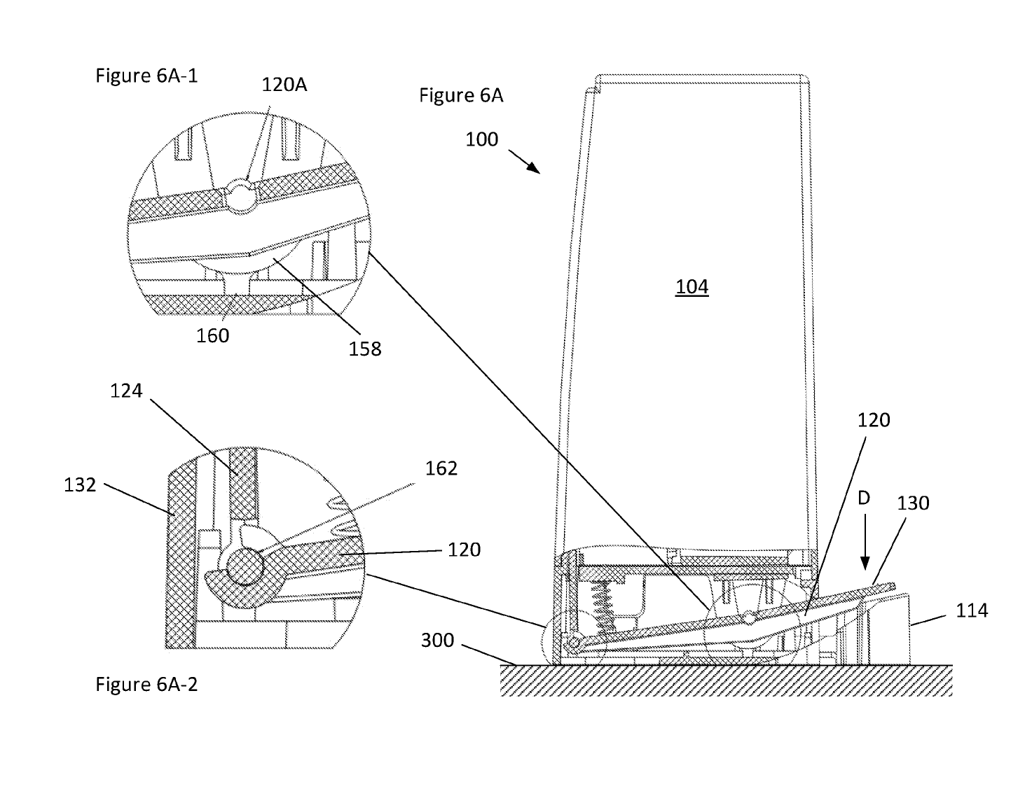

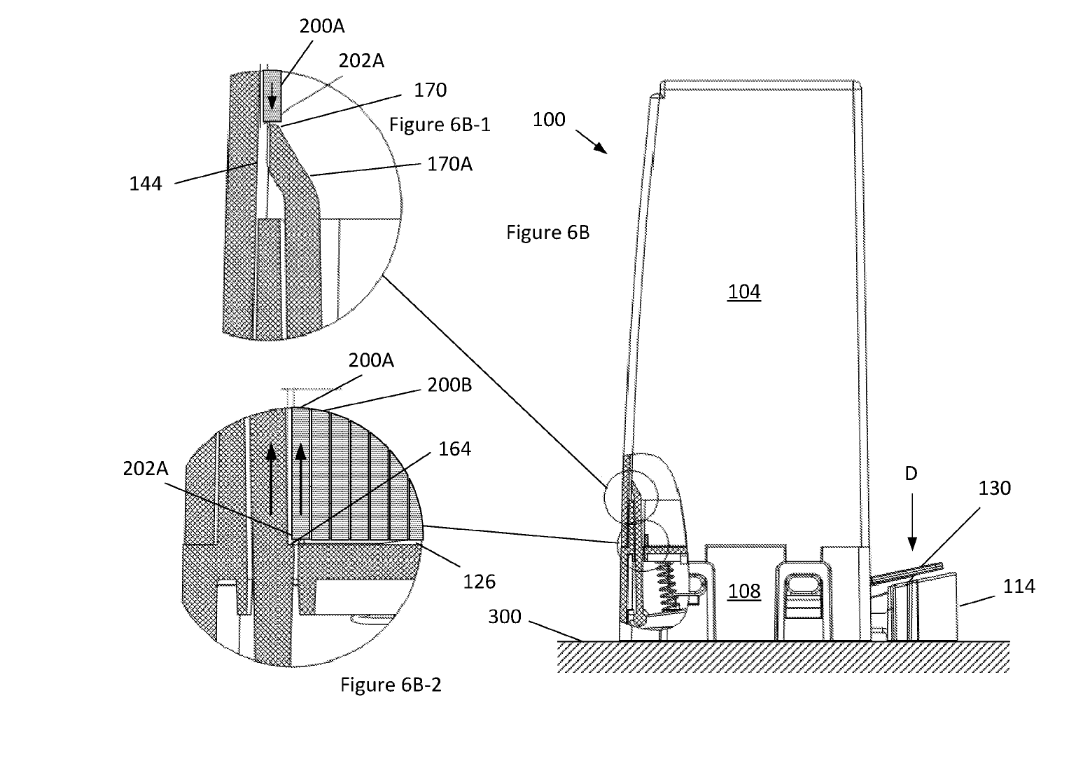

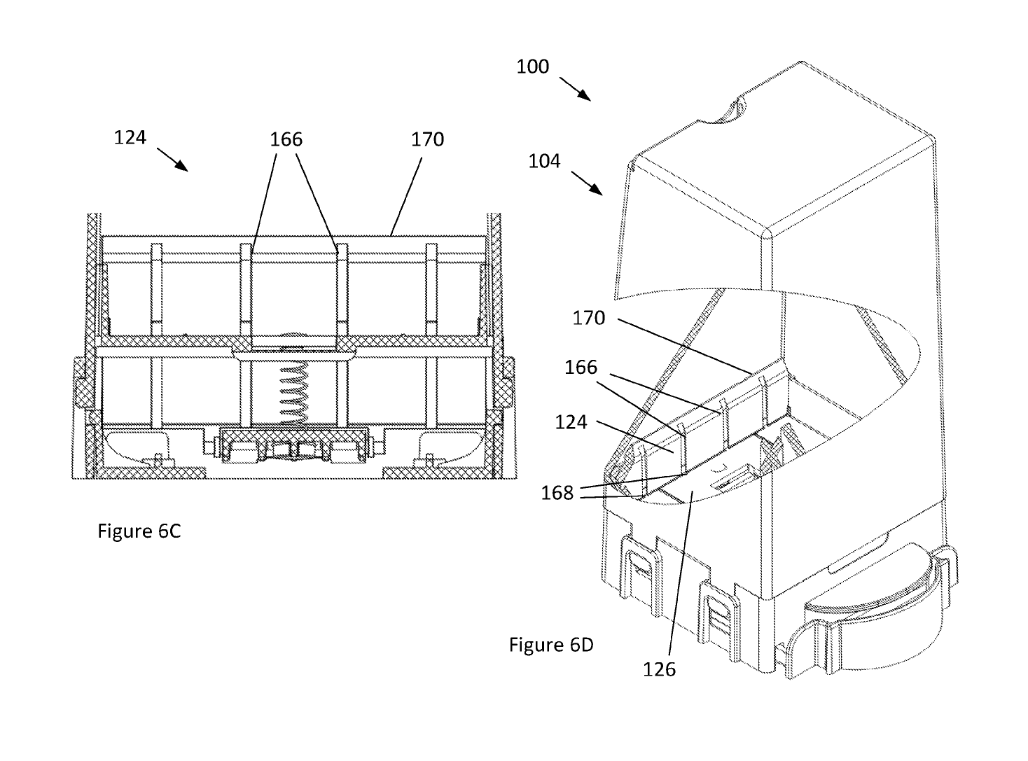

FIGS. 6A to 6D illustrate various aspects of the dispensing mechanism 112. The dispensing lever 120 has pivoting pegs 120A on which the lever is pivotably mounted in support brackets 158 on the underside of the ticket rack 108. The support brackets 158 have strengthening legs 160 that extend to rest on the counter base 106, and enable the support brackets to withstand a larger force and to reduce distortion of the ticket platform 126, during a dispensing operation. The dispensing lever 120 has a depressible end 130, which the operator depresses D (i.e. presses towards the retail counter 300, onto which the counter base 106 is mounted). A spring 122 engages with the ticket rack 108 and the dispensing lever 120, and biases the lever into a position of readiness for dispensing, in which the depressible end 130 is raised, and returns the lever to this position after each ticket is dispensed. The dispensing lever 120 and the ticket ejector 124 are connected by a pivotable connection 162, and in use, when the depressible end 130 is depressed D by an operator, the ticket ejector is raised (i.e. moved away from the counter base 106 and towards the dispensing slot 134), thereby raising just the first ticket 200A, so that it is dispensed through the dispensing slot.

The side of the ticket ejector 124 facing the pack of tickets 200 is provided with a lifting ledge 164 (i.e. a type of ticket edge engagement feature) for engaging with the only first ticket 200A during a dispensing operation. The lifting ledge 164 is narrower than the thickness of the ticket 200A, to prevent engagement of the ledge with the second ticket 200B (e.g. in the case of tickets having a typical thickness of 0.6 to 0.7 mm, the ledge is no more than 0.5 mm wide).

As shown in FIGS. 6C and 6D, the side of the ticket ejector 124 facing the pack of tickets 200 is provided with grooves 166 parallel to the direction of travel of the ticket ejector during dispensing, and the ticket rack 108 is provided with teeth 168 that extend from the ticket support platform 126 into the grooves. As the ticket ejector 124 is moved during a dispensing operation, the teeth 168 of the ticket platform 126 slide within the grooves 166. Accordingly, the inter-engagement of the teeth 168 in the grooves 166 prevents the possibility of a gap extending across the width of the ticket between the ticket ejector 124 and rack 108, into which the first edge 202A of a ticket 200A could fall, which could otherwise result in the ticket dispensing mechanism 112 becoming jammed. Alternatively, the teeth may be provided on the ticket ejector and the grooves may be provided in the adjacent surface of the rack 108.

The ticket ejector 124 has a leading edge 170, being the edge closest to the ticket dispensing slot 134. The pack of tickets 200 is biased towards the front wall 132, and pressing upon the ticket ejector 124, and the leading edge 170 of the ticket ejector is maintained against or close to the inner surface 144 of the front wall 132. The leading edge 170 of the ticket ejector 124 is separated from the inner surface 144 of the front wall 132 by less than the thickness T of a ticket 200A. The leading edge 170 of the ticket ejector 124 has a bevelled shape, with a bevelled surface 170A facing towards the ticket pack. Accordingly, if a customer should decline the first ticket 200A after it has been fully or partially dispensed by the dispensing mechanism 112 into a raised position, and if the retailer should push the ticket back into the ticket housing 104, the first edge 202A of the ticket will slide back to the front of the ticket pack, and the ticket will be prevented from passing between the ticket ejector 124 and the front wall 132, which could otherwise jam the ticket dispensing mechanism. Further, the bevelled edge 170A will guide the first edge 202A back into alignment with the rest of the ticket pack 200, in contact the lifting edge 164, in readiness for a further dispensing action.

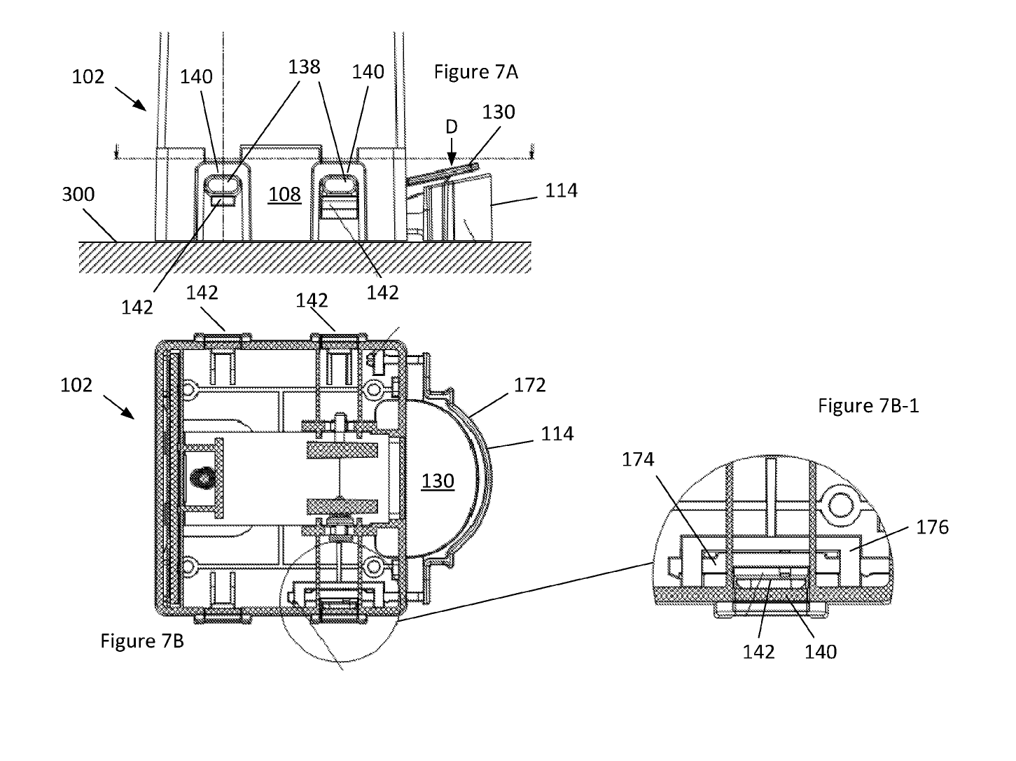

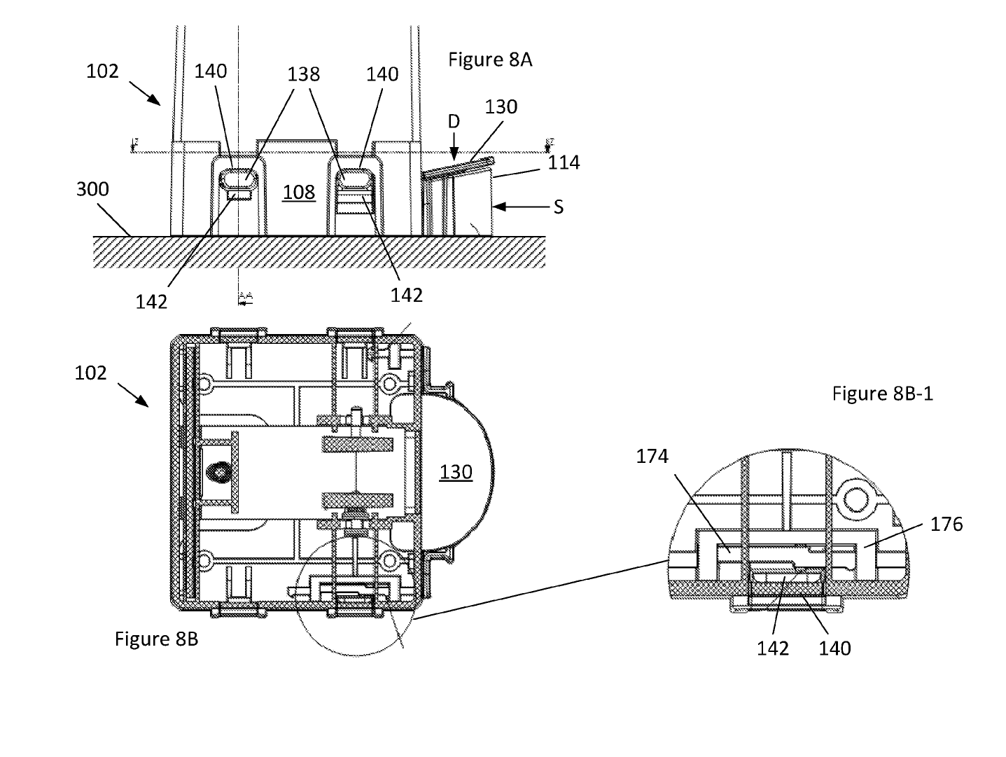

FIGS. 7A to 7B-1 show the lock 114 in an unlocked position, in which the dispensing mechanism 112 may be operated by depressing the depressible end 130, and in which the housing 104 and/or ticket rack assembly 102 may be detached from the counter base 106 (which may be securely attached to a retail counter 300). In contrast, FIG. 8A to 8B-1 show the lock 114 in a locked position, in which the dispensing mechanism 112 cannot be operated by depressing the depressible end 130, and in which the housing 104 and/or rack assembly 102 cannot be detached from the counter base 106, and so cannot be detached from the retail counter 300).

The lock 114 comprises a curtain-like slideable wall 172. In the unlocked position, the depressible end 130 may be depressed D to pass between the slideable wall 172 of the lock 114 and the ticket rack 108, thereby operating the dispensing mechanism 112, as explained above. To lock the dispensing mechanism 112, the lock 114 is slid S towards the ticket rack 108, under the depressible end 130, thereby obstructing depression of the depressible end and operation of the dispensing mechanism.

As described above, the ticket rack assembly 102 is detachably connected to the counter base 106, by second resiliently deformable clipping arms 142, which are configured to engage in the clipping windows 140 in the ticket rack 108. The ticket rack assembly 102 is detachable from the counter base 106 by pressing in the ends of the second clipping arms 142, so that the clipping arms resiliently deform and become disengaged from the clipping windows 140. The lock 114 comprises a slideable locking member 174, which extends between at least one of the second clipping arms 142 and a lock bracing bracket 176, and the slideable locking member is configured to enable resilient deformation of the corresponding second clipping arm when in the unlocked position, but which obstructs resilient deformation of the corresponding second clipping arm when in the locked position. In particular, when in the locked position, the slideable locking member 174 is braced against the lock bracing bracket 176 to resist the deformation of the corresponding second clipping arm, if an attempt should be made to disengage the ticket rack assembly 102 from the corresponding clipping window 140.

FIGS. 7A to 8B-1 illustrate a two-function lock 114 that simultaneously (i) locks the dispensing mechanism and (ii) locks removal of the rack assembly and/or housing from a retail counter. Alternatively the lock may provide only one of the two functions. Further, the ticket dispenser may comprise two locks, each providing one of the two functions.

The figures provided herein are schematic and not to scale.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A ticket dispenser for dispensing a ticket from a pack of tickets having first and last tickets at opposite ends of the pack and each ticket having opposed first and second edges, the ticket dispenser comprising:
a ticket rack assembly having a rack with a support platform for receiving the pack of tickets with first edges against the support platform, and a ticket pack biasing mechanism configured to press against a face of the last ticket of the pack and to urge the last ticket towards the first ticket;
a ticket housing for preventing unauthorised external access o the pack of tickets, the ticket housing comprising a ticket dispensing slot; and
a ticket dispensing mechanism configured to dispense the first ticket from the pack of tickets, the ticket dispensing mechanism comprising a dispensing control member connected to a ticket ejector, the ticket ejector having a ticket edge engagement feature configured to engage with a first edge of the first ticket, the ticket ejector being operable by movement of the dispensing control member to slide the first ticket from the pack and away from the platform and to dispense the second edge of the first ticket through the ticket dispensing slot,
wherein the ticket pack biasing mechanism is configured to bias the pack of tickets towards a customer-facing side of the housing,
wherein an inner surface of the customer-facing side of the housing is configured to contact and guide the second edge of the first ticket towards the dispensing slot as the second edge of the first ticket traverses a gap between the ticket pack and the ticket dispensing slot as the first ticket is dispensed, and
wherein the inner surface of the customer-facing side of the housing is configured to reduce buckling of the second edge of the first ticket as the second edge of the first ticket traverses a gap between the ticket pack and the ticket dispensing slot as the first ticket is dispensed.

2. The ticket dispenser according to claim 1, wherein the ticket dispensing mechanism comprises a dispensing lever, part of the lever comprising the dispensing control member and being operable to drive the ticket ejector.

3-4. (canceled)

5. The ticket dispenser according to claim 1, wherein the ticket ejector is pivotably connected to the dispensing control member.

6. The ticket dispenser according to claim 1, wherein the ticket ejector has a leading edge, which is shaped to deflect an approaching first edge of a ticket towards the ticket pack, in the event that a partially dispensed ticket is returned to the pack.

7. The ticket dispenser according to claim 6, wherein the leading edge of the ticket ejector comprises a bevelled face that faces towards the ticket pack.

8. The ticket dispenser according to claim 1, wherein the ticket edge engagement feature is less than 0.5 mm wide.

9. The ticket dispenser according to claim 1, wherein the ticket ejector and an adjacent edge of the support platform comprise an arrangement of engagement projections and corresponding recesses configured for slideable mutual engagement throughout the range of movement of the ticket ejector during dispensing.

10-11. (canceled)

12. The ticket dispenser according to claim 1, wherein the ticket housing is configured for a display face of the first ticket to be viewable by a customer prior to the first ticket being dispensed.

13. The ticket dispenser according to claim 12, wherein the housing is transparent or the customer-facing side of the housing comprises a viewing window for viewing a display face of the first ticket.

14. (canceled)

15. The ticket dispenser according to claim 1, wherein the inner surface of the customer-facing side of the housing is configured to extend partially over a pack of tickets on the support platform.

16. The ticket dispenser according to claim 1, wherein the inner surface of the customer-facing side of the housing comprises guiding ribs configured to contact and guide the second edge of the first ticket towards the dispensing slot, as the first ticket is dispensed.

17. The ticket dispenser according to claim 1, wherein the inner surface of the customer-facing side of the housing is angled at an acute angle to the support platform.

18. The ticket dispenser according to claim 1, wherein the inner surface of the customer-facing side of the housing is concavely curved.

19-21. (canceled)

22. The ticket dispenser according to claim 1, wherein the housing has an operator-facing side opposed to the customer-facing side, and wherein the dispensing control member projects from the operator-facing side, and either the ticket dispensing slot is provided adjacent the customer-facing side in a top face of the housing, or the ticket dispensing slot is provided in the customer-facing side of the housing.

23. The ticket dispenser according to claim 1, wherein the ticket dispensing slot has a plurality of slot projections extending into the ticket dispensing slot from an edge of the ticket dispensing slot and being configured to reduce the maximum dispensing width of the ticket dispensing slot below the width of the ticket dispensing slot in regions of the ticket dispensing slot from which projections are absent.

24. The ticket dispenser according to claim 23, wherein the slot projections extend into the ticket dispensing slot from an edge of the ticket dispensing slot adjacent the top face of the housing.

25. The ticket dispenser according to claim 24, wherein the slot projections are in end regions of the ticket dispensing slot.

26. The ticket dispenser according to claim 23, wherein the projections are configured to limit a maximum dispensing thickness of the ticket dispensing slot to less than 1.2 mm.

27. The ticket dispenser according to claim 1, wherein the width of the ticket edge engagement feature is 40 to 60% of a maximum dispensing thickness of the ticket dispensing slot.

28. (canceled)

29. The ticket dispenser according to claim 1, wherein the ticket edge engagement feature is less than half the minimum width of the ticket dispensing slot.

30. (canceled)
